(19) United States
(12) Patent Application Publication
(10) Pub. No.: US 2021/0370602 A1
(43) Pub. Date: Dec. 2, 2021

(54) DETERMINE RATIOS OF BUILD MATERIALS TO ACHIEVE SELECTED FEATURES

(71) Applicant: Hewlett-Packard Development Company, L.P., Spring, TX (US)

(72) Inventors: Emily Ann MIGINNIS, San Diego, CA (US); Jesiska TANDY, San Diego, CA (US); Erica FUNG, San Diego, CA (US); Yow Wei CHENG, Taipei (TW)

(73) Assignee: Hewlett-Packard Development Company, L.P., Spring, TX (US)

(21) Appl. No.: 17/051,133

(22) PCT Filed: Oct. 1, 2018
(86) PCT No.: PCT/US2018/053771

§ 371 Date: Oct. 27, 2020

(51) Int. Cl. B29C 64/314; B29C 64/357; B29C 64/393; G06T 7/00; G06T 7/80; B33Y 10/00; B33Y 50/02

(52) U.S. Cl. CPC B29C 64/314; B29C 64/357; B29C 64/393; B33Y 50/02; G06T 7/80; B33Y 10/00; G06T 7/0004

(57) ABSTRACT

According to an example, an apparatus may include a processor and a non-transitory computer readable medium on which is stored machine readable instructions that are to cause the processor to determine an optical property value of a first build material from an image of a sample of the first build material, calculate an age of the first build material from the determined optical property value of the first build material, and based on the calculated age of the first build material, calculate a ratio of a mixture of the first build material and a second build material that results in the mixture achieving a selected feature, the second build material having a different age than the first build material.

### BACKGROUND

In three-dimensional (3D) printing, an additive printing process may be used to make three-dimensional solid parts from a digital model. 3D printing may be used in rapid product prototyping, mold generation, mold master generation, and manufacturing. Some 3D printing techniques are considered additive processes because they involve the application of successive layers of material to an existing surface (template or previous layer). This is unlike traditional machining processes, which often rely upon the removal of material to create the final part. 3D printing may involve curing or fusing of the building material, which for some materials may be accomplished using heat-assisted melting or sintering, and for other materials may be performed through UV curing of polymer-based build materials.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may calculate a ratio of a mixture of build materials such that the mixture may achieve a selected feature;

FIG. 2 shows a diagram of an example system that includes the apparatus depicted in FIG. 1 and a test station at which an image of a build material sample may be captured;

FIG. 3 shows a block diagram of an example apparatus that may calculate a ratio of a mixture of build materials such that the mixture has a selected feature;

FIG. 4 shows a flow diagram of an example processor respectively depicted in FIGS. 1 and 3, in which the processor may control a build cycle of a 3D fabrication system;

FIG. 5 shows a block diagram of an example 3D fabrication system;

FIG. 6 depicts an example method for calculating a ratio of a mixture of build materials such that the mixture may achieve a selected feature;

FIG. 7 depicts an example method for capturing an image of the first build material sample;

FIG. 8 depicts a flow diagram of an example method for calculating an optimized white balance value for an imaging device;

FIGS. 9A and 9B, collectively, depict a flow diagram of an example method for determining an age of a build material; and

FIG. 10 depicts a block diagram of an example non-transitory computer readable medium.

### DETAILED DESCRIPTION

3D printing technologies that employ build material to print 3D objects often take unused build material from previous build cycles for reuse in subsequent build cycles. In 3D printing technologies that use heat to the selectively fuse build material during the build cycles, the molecular structure of the fused and unfused build material may change each time the build material undergoes a build cycle. That is, the molecular structure of the build material may change because the build material may be heated to a temperature that may at least be close to a melting point of the build material. The change in molecular structure may negatively affect the mechanical and/or material properties of 3D objects fabricated using build material that has undergone a build cycle or multiple build cycles. However, the use of only fresh build material for each build cycle may significantly result in increased build cost and increased build material waste.

Disclosed herein are apparatuses and methods for enabling reuse of build material that has previously undergone a build cycle or multiple build cycles, while causing 3D objects fabricated from the reused build material (which is also referenced herein as a first build material) to have a selected optical and/or mechanical property. Particularly, the apparatuses and methods disclosed herein may determine an optical property value of the reused build material from an image or a video stream of a sample of the reused build material. The apparatuses and methods disclosed herein may also calculate, from the determined optical property value and an optical property value of a second build material, a ratio of the reused build material and the second build material to be mixed together to achieve a selected feature. The selected feature, e.g., an optical feature, a mechanical feature, etc., may be of the mixture and/or of a 3D object to be fabricated using the mixture.

In some examples, the apparatuses and methods disclosed herein may determine an age of the first build material based on the determined optical property value. The age may define the apparent number of times that the first build material has undergone a build cycle and may thus be indicative of a feature of the first build material and/or a feature of a 3D object to be fabricated using the first build material. The second build material may also have an age, which may differ from the age of the first build material. In these examples, the apparatuses and methods disclosed herein may calculate the ratio of the first build material and the second build material based on the determined ages of the first build material and the second build material.

According to examples, the apparatuses and methods disclosed herein may determine the ratio to include a maximum concentration of the first build material and a minimum concentration of the second build material. In this regard, the apparatuses and methods disclosed herein may maximize recycling of the previously used build material while still achieving the selected feature with the mixture. In addition, the use of the second build material, which may be fresh build material, may be minimized, while achieving the selected feature with the mixture.

According to examples, the apparatuses and methods disclosed herein may calculate a feature, e.g., an optical, a mechanical, and/or the like, of a mixture at a selected ratio of a first build material and a second build material prior to the first build material and a second build material being mixed together. For instance, the feature may be calculated based on historical data and/or through implementation of a predictive model according to optical property values of the first build material and the second build material.

Through implementation of the apparatuses and methods disclosed herein, optical property values of build materials may be determined in a non-invasive and non-cumbersome manner. In addition, the determined optical property values may be used as a basis for determining a ratio at which the build materials may be combined to achieve a selected feature of the mixture and/or a 3D object to be fabricated using the mixture. In one regard, therefore, build material that was previously used in a build cycle may be reused while meeting a selected feature, e.g., a user-defined feature, an intended feature, etc.

Before continuing, it is noted that as used herein, the terms “includes” and “including” mean, but is not limited to, “includes” or “including” and “includes at least” or “including at least.” The term “based on” means “based on” and “based at least in part on.”

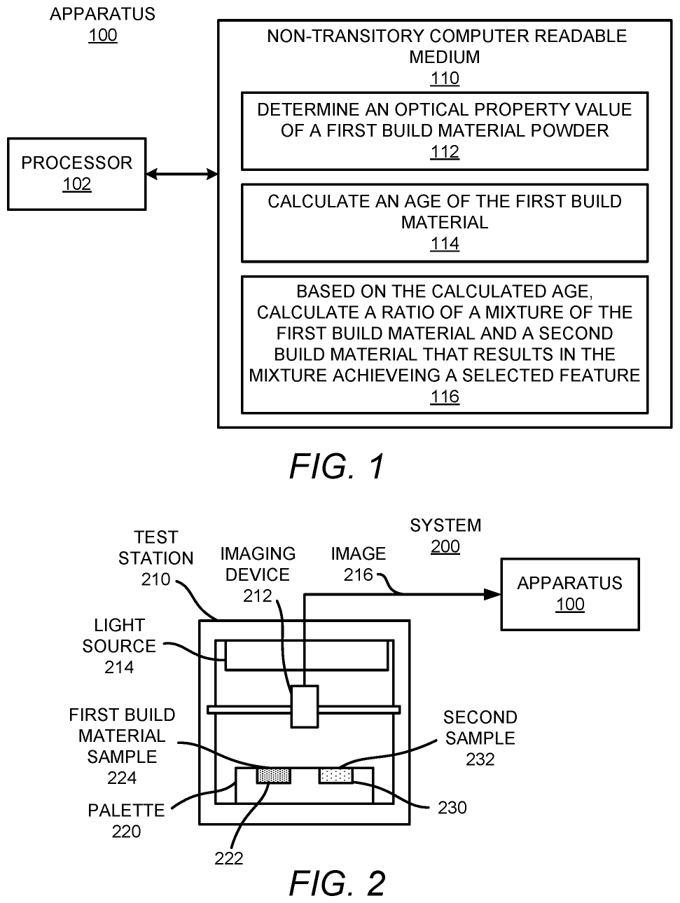

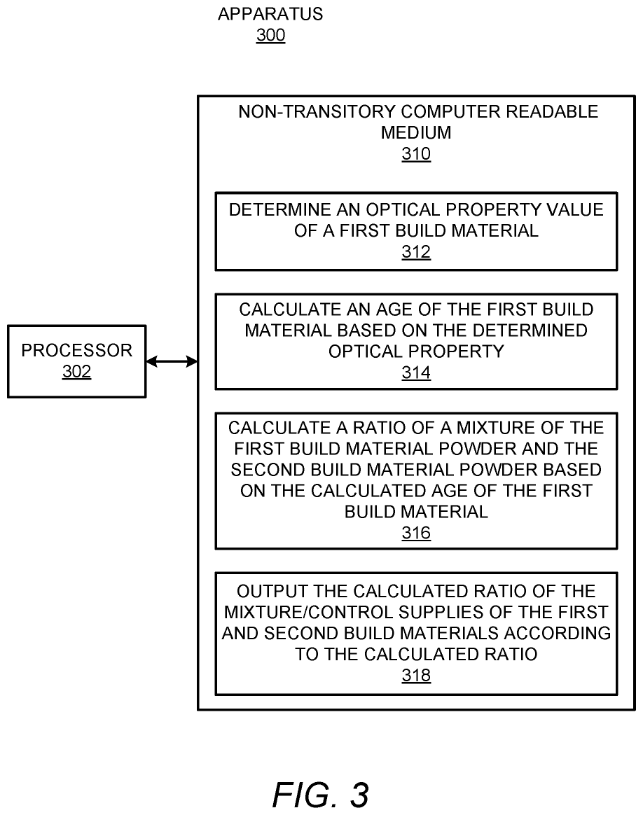

Reference is first made to FIGS. 1 and 2. FIG. 1 shows a block diagram of an example apparatus 100 that may calculate a ratio of a mixture of build materials such that the mixture may achieve a selected feature. FIG. 2 shows a block diagram of an example system 200 that includes the apparatus 100 and a test station 210 at which an image of a build material sample may be captured. It should be understood that the apparatus 100 depicted in FIG. 1 and/or the system 200 depicted in FIG. 2 may include additional components and that some of the components described herein may be removed and/or modified without departing from the scopes of the apparatus 100 and/or the system 200 disclosed herein.

The apparatus 100 may be a computing apparatus, e.g., a personal computer, a laptop computer, a tablet computer, a smartphone, or the like. In these examples, the apparatus 100 may be separate from a 3D fabrication system and may communicate instructions to the 3D fabrication system over a direct or a network connection. In other examples, the apparatus 100 may be part of a 3D fabrication system or another manufacturing method system. In these examples, the apparatus 100 may be part of a control system of the 3D fabrication system and may communicate instructions to components of the 3D fabrication system, for instance, over a communication bus. By way of example, a processor 102 of the apparatus 100 may communicate instructions to or otherwise control the components of the 3D fabrication system to fabricate a 3D object from layers of build material, in which the build material may include a certain mixture of a first build material and a second build material, although additional build materials may also be used in the mixture.

As shown in FIG. 1, the apparatus 100 may include a processor 102 that may control operations of the apparatus 100. The processor 102 may be a semiconductor-based microprocessor, a central processing unit (CPU), an application specific integrated circuit (ASIC), a field-programmable gate array (FPGA), a graphics processing unit (GPU), a tensor processing unit (TPU), and/or other hardware device. The apparatus 100 may also include a non-transitory computer readable medium 110 that may have stored thereon machine readable instructions 112-116 (which may also be termed computer readable instructions) that the processor 102 may execute. The non-transitory computer readable medium 110 may be an electronic, magnetic, optical, or other physical storage device that contains or stores executable instructions. The-transitory computer readable medium 110 may be, for example, Random Access memory (RAM), an Electrically Erasable Programmable Read-Only Memory (EEPROM), a storage device, an optical disc, and the like. The term “non-transitory” does not encompass transitory propagating signals.

The processor 102 may fetch, decode, and execute the instructions 112 to determine an optical property value of a first build material from an image or a video stream of a sample of the first build material. As used herein the term “image” may be defined as being a still image and/or a video stream. As shown in FIG. 2, the test station 210 may support an imaging device 212 (such as a camera, a smartphone, a tablet, a webcam, or the like, and a light source 214. The light source 214 may illuminate a top portion of a palette 220 and the imaging device 212 may capture an image 216 or multiple images (e.g., a video stream) of the illuminated top portion of the palette 220. The imaging device 212 may also be rotatable such that the imaging device 212 may capture an image of the light source 214 during a calibration and validation process as discussed herein. As used throughout the present disclosure, an “image,” a “captured image,” or a live stream may also be construed as referring to a set or series of images, which may include a video stream. In this regard, the imaging device 212 may be a digital still imaging device and/or a digital video imaging device.

The optical property value of the first build material may pertain to a color, a glossiness, a translucency, a transparency, and/or the like, of the first build material. The processor 102 may determine the optical property value through an analysis of features of the first build material image. For instance, the processor 102 may identify the color of the first build material in the image, e.g., RGB color value, LAB color space value, and/or the like. In another example, the processor 102 may identify a glossiness, translucency, or the like, of the first build material in the image. In some examples, the processor 102 may determine optical property values at multiple locations of the image and may determine the optical property value of the first build material based on the application of a function, e.g., an averaging function, a mean value function, a median value function, a weighted average value function, etc.

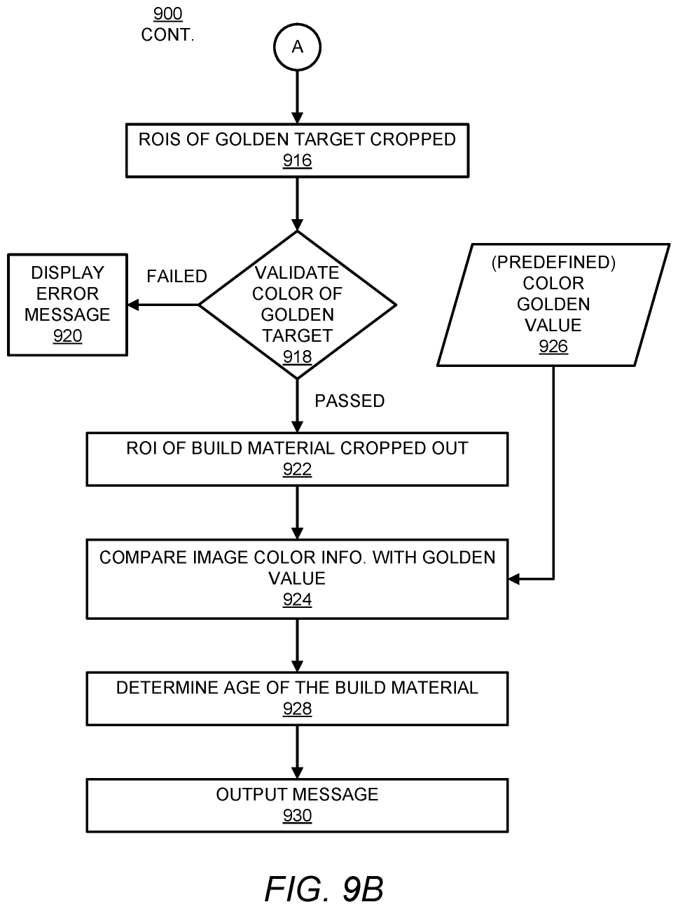

As shown in FIG. 2, the palette 220 may include a tray or other support location 222 in which a first build material sample 224 may be contained. The palette 220 may be removable from the test station 210 and may also include another tray or support location 230 that may house a second sample 232. The second sample 232 may be a sample of build material or other material, e.g., a sheet of media, for which an optical property value may be known. The second sample 232 may be a golden target as discussed herein below with respect to FIG. 9. According to examples, the imaging device 212 may be flipped up to capture an image of light emitted by the light source 214 and the captured image of the light may be used for calibration and validation purposes of the imaging device 212. For instance, a captured image or video images of the light from the light source 214 may be sent to the apparatus 100 and the processor 102 may perform a calibration and validation process of the imaging device 212 using the captured image or captured video images of the captured light. Following capture of the image or video images of the light emitted by the light source 214, the imaging device 212 may be flipped back toward the palette 220 to capture an image 216 of the first build material sample 224 and the second sample 232.

Although not shown, the palette 220 may include additional trays that may hold additional build materials that may have undergone various build cycles. For instance, the additional build materials may be build materials that may have been used on other fabrication systems. In this regard, for instance, the processor 102 may determine the optical property values of each of the additional build materials concurrently, e.g., from a common image of the top of the palette 220.

In some examples, the first build material sample 224 may include build material that was unused during a 3D object build operation and that may be housed for re-use or recycling. Unused build material may be build material that was not fused together and/or was not bound together during the 3D object build operation. As discussed herein, during the 3D object build operation, the first build material may be heated to a temperature that may be close to a melting point temperature of the first build material. In any of these examples, the molecular structure of the first build material may change during the 3D object build operation. In some instances, the application of heat onto the first build material may cause an optical and/or mechanical property of the first build material to change. In addition, putting the first build material through additional build cycles may cause the property of the first build material to further change.

The processor 102 may fetch, decode, and execute the instructions 114 to calculate an age of the first build material from the determined optical property value of the first build material. Various manners in which the processor 102 may calculate the age of the first build material are described herein.

The processor 102 may fetch, decode, and execute the instructions 116 to, based on the calculated age of the first build material, calculate a ratio of a mixture of the first build material and a second build material that results in the mixture achieving a selected feature. The second build material may have a different optical property value than the first build material and may thus have a different age than the first build material. The second build material may be a build material that has undergone a different number of build cycles as compared with the first build material. For instance, the second build material may have undergone a fewer number of build cycles, e.g., no build cycles in which case the second build material may be fresh build material. In instances in which the second build material has undergone a build cycle, the processor 302 may determine the number of build cycles that the second build material has undergone (e.g., the age of the second build material) in similar manners to those discussed above with the determination of the number of build cycles that the first build material has undergone.

In any regard, because the second build material may have undergone a different number of build cycles as compared with the first build material, the second build material may have a different optical property value than the first build material. As a result, a feature, e.g., an optical and/or mechanical feature, of a mixture of the first build material and the second build material may differ from both the feature values of the first build material and the second build material. The feature of the mixture may also vary depending upon the concentration of the first build material and the concentration of the second build material in the mixture. For instance, if the first build material is darker in color than the second build material, a larger concentration of the first build material may result in the mixture having a darker color than a smaller concentration of the first build material.

According to examples, testing of mixtures containing various concentrations, e.g., ratios, of build materials having different optical property values may have been conducted and the results of the various concentrations on a property of the build material mixture may have been determined. In addition or in other examples, testing of mixtures containing various concentrations of build materials having different optical property values may have been conducted and the results of the various concentrations on a property of a 3D object to be fabricated using the mixture may have been determined. In any of these examples, the correlations between the various concentrations of the build materials and the properties of the mixture and/or a 3D object to be fabricated determined through the testing may be stored in a lookup table. The lookup table may be stored in a database, which may be part of the apparatus 100 or may be outside of the apparatus 100.

In some examples, a predictive model may be generated, in which the predictive model may mathematically correlate the various concentrations of the build materials and the features of the mixture and/or a 3D object to be fabricated. The predictive model may be generated using some of the testing data, for instance, through an analysis of trends in the correlations that may have been identified during the testing.

In the examples discussed above, the processor 102 may access the database to calculate the ratio of the mixture of the first build material and the second build material that may result in the mixture achieving the selected feature. In these examples, the processor 102 may identify, from the database, which may include a table, which ratio of a first build material having a first optical property value and a second build material having a second optical property value results in the selected feature. In addition or alternatively, the processor 102 may input the optical property value of the first build material, the optical property value of the second build material, and the selected feature into the predictive model to calculate the ratio of the mixture that results in the mixture achieving the selected feature.

In any of the examples above, the feature may be an optical feature, such as a color, a glossiness, a translucency, a transparency, a texture, and/or the like, of the mixture and/or of the 3D object to be fabricated. The feature may additionally or alternatively be a physical feature, a material feature, a chemical feature, or a combination thereof of the build materials and/or a 3D object to be fabricated using the mixture. By way of example, the physical feature may be a strength, an elasticity, a hardness, a brittleness, and/or the like, of the build materials and/or a 3D object to be fabricated using the mixture.

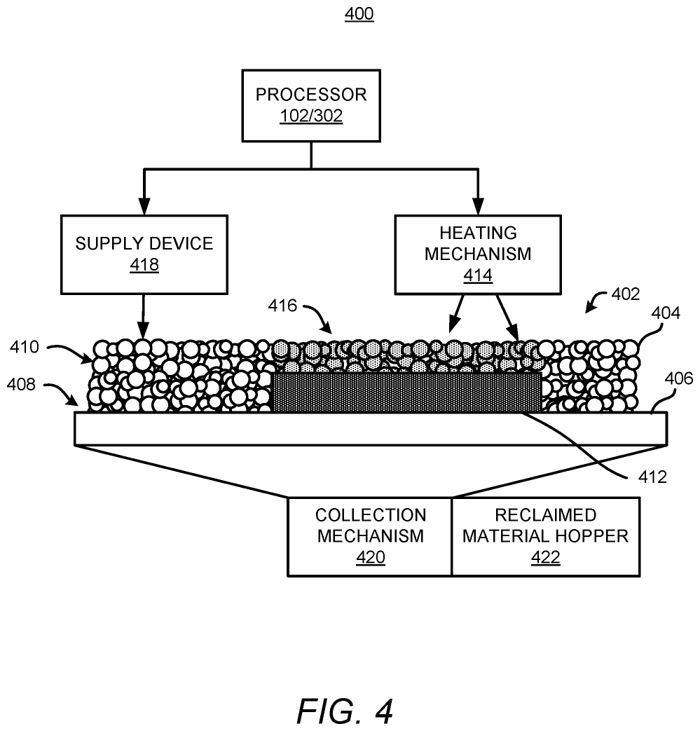

Reference now made to FIG. 3, which shows a block diagram of an example apparatus 300 that may calculate a ratio of a mixture of build materials such that the mixture has a selected feature. It should be understood that the apparatus 300 depicted in FIG. 3 may include additional components and that some of the components described herein may be removed and/or modified without departing from the scope of the apparatus 300 disclosed herein.

The apparatus 300 may be similar to the apparatus 100 depicted in FIGS. 1 and 2. As shown in FIG. 3, the apparatus 300 may include a processor 302 that may control operations of the apparatus 300 and a non-transitory computer readable medium 310. The processor 302 may be similar to the processor 102 and the non-transitory computer readable medium 310 may be similar to the non-transitory computer readable medium 110 depicted in FIG. 1.

The processor 302 may fetch, decode, and execute the instructions 312 to determine an optical property value of a first build material from an image of a sample of the first build material. The image of the first build material sample may have been captured and received as discussed above with respect to FIG. 2.

The processor 302 may fetch, decode, and execute the instructions 314 to calculate an age of the first build material based on the determined optical property, in which the age of the first build material may correspond to an apparent number of build cycles that the first build material has undergone. That is, the age of the first build material may correspond to a number of times that the first build material was previously heated during the build cycles. In some examples, the first build material may include a mixture of build materials having different ages as the different aged build materials may have been mixed together for the build cycles. According to examples, the processor 302 may calculate the age based on the multiple optical property values, such as by calculating an average age of the multiple ages.

According to examples, the optical property values of the build materials after the build materials have undergone known numbers of build cycles may be determined and correlations between the determined optical property values and the number of build cycles that the build materials have undergone may be stored in a database, e.g., in a lookup table. In some examples, a predictive model may be generated, in which the predictive model may mathematically correlate the number of build cycles and the resulting optical property values. The predictive model may be generated using some of the test data, for instance, through an analysis of trends in the correlations that may have been identified during the testing.

In the examples discussed above, the processor 302 may access the lookup table to calculate the age of the first build material. In these examples, the processor 302 may identify, from the lookup table, which age or apparent age corresponds to the determined optical property value of the first build material. In addition or alternatively, the processor 302 may input the optical property value of the first build material into the predictive model corresponding to the ages of the build material to calculate the age or apparent age of the first build material.

The processor 302 may fetch, decode, and execute the instructions 316 to, based on the determined age of the first build material, calculate a ratio of a mixture of the first build material and a second build material that results in the mixture achieving a selected feature, the second build material having a different optical property value than the first build material. The selected feature may pertain to the mixture and/or a part to be fabricated using the mixture as discussed herein. As also discussed herein, the second build material may be a build material that has undergone a different number of build cycles as compared with the first build material. For instance, the second build material may have undergone a fewer number of build cycles, e.g., no build cycles, in which case the second build material may be fresh build material.

In instances in which the second build material has undergone a build cycle, the processor 302 may determine the age of the second build material in similar manners to those discussed above with the determination of the age of the first build material. In other examples, the age of the second build material may be inputted or the processor 302 may otherwise be informed of the age.

The processor 302 may fetch, decode, and execute the instructions 318 to output the calculated ratio of the mixture. For instance, the processor 302 may output the calculated ratio to a display such that a user may view the calculated ratio. In these examples, the user may manually mix the first build material and the second build material at the calculated ratio. In addition or alternatively, the processor 302 may fetch, decode, and execute the instructions 318 to control a supply of the first build material from a first bin that stores the first build material and a supply of the second build material from a second bin that stores the second build material. Various manners in which the processor 302 may control the supply of the first and second build materials are discussed herein.

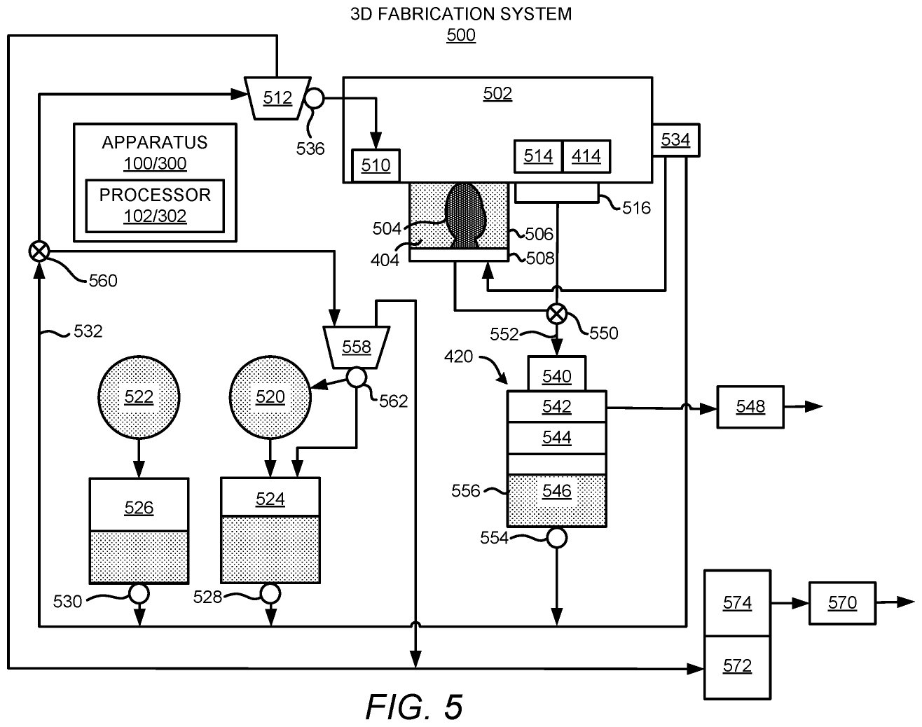

Turning now to FIG. 4, there is shown a diagram 400 of an example processor 102, 302, respectively depicted in FIGS. 1 and 3, in which the processor 102, 302 may control a build cycle of a 3D fabrication system. As shown, a batch 402 of build material 404, which may include multiple particles, may be supplied on a build platform 406 of the 3D fabrication system. The build material 404 may be formed of any suitable material including, but not limited to, plastics, polymers, metals, and ceramics and may be in the form of a powder or a powder-like material. References made herein to “powder” should also be interpreted as including “power-like” materials.

Additionally, the build material 404 may be formed to have dimensions, e.g., widths, diameters, or the like, that are generally between about 5 μm and about 100 μm. In other examples, the build material 404 may have dimensions that are generally between about 30 μm and about 60 μm. The build material 404 may generally have spherical shapes, for instance, as a result of surface energies of the particles in the build material and/or processes employed to fabricate the particles. The term “generally” may be defined as including that a majority of the particles in the build material 404 have the specified sizes and spherical shapes. In other examples, the term “generally” may be defined as a large percentage, e.g., around 80% or more of the particles have the specified sizes and spherical shapes. The build material 404 may additionally or alternatively include short fibers that may, for example, have been cut into short lengths from long strands or threads of material.

During fabrication of the 3D object, the build material 404 may be provided on the build platform 406 in multiple layers 408, 410. In layer 408, a section 412 of a 3D object is depicted as having been formed through fusing of the build material 404 in that section 412, for instance, through application of heat from a heating mechanism 414. In addition, the build material 404 in the section 416 is depicted as undergoing a fusing process to thus fuse the section 416 with the section 412. That is, a supply device 418 may have applied a fusing agent onto the build material 404 in the section 416 and the heating mechanism 414 may apply heat onto the layer 410 of build material 404 to melt the build material 404 in the section 416. This process may be repeated on subsequent layers and sections to form the 3D object during a build cycle.

According to examples, the fusing agent may enhance absorption of heat from the heating mechanism 414 to heat the build material 404 to a temperature that is sufficient to cause the build material 404 upon which the fusing agent has been deposited to melt. In addition, the heating mechanism 414 may apply heat, e.g., in the form of heat and/or light, at a level that causes the build material 404 upon which the fusing agent has been applied to melt without causing the build material 404 upon which the fusing agent has not been applied to melt. In addition, in some examples, the heating mechanism 414 may be controlled to apply heat in a certain manner to cause the build material 404 to acquire certain build properties.

According to one example, a suitable fusing agent may be an ink-type formulation including carbon black, such as, for example, the fusing agent formulation commercially known as V1Q60A “HP fusing agent” available from HP Inc. In one example, such a fusing agent may additionally include an infra-red light absorber. In one example, such an ink may additionally include a near infra-red light absorber. In one example, such a fusing agent may additionally include a visible light absorber. In one example, such an ink may additionally include a UV light absorber. Examples of inks including visible light enhancers are dye-based colored ink and pigment-based colored ink, such as inks commercially known as CE039A and CE042A available from HP Inc. According to one example, a suitable detailing agent may be a formulation commercially known as V1Q61A “HP detailing agent” available from HP Inc. According to one example, a suitable build material may be PA12 build material commercially known as V1R10A “HP PA12” available from HP Inc. According to one example, the fusing agent may be a low tint fusing agent (LTFA).

As also shown in FIG. 4, a collection mechanism 420 may be provided to reclaim the unused build material 404 following fabrication of the 3D object from the build material 404 that have been fused and/or bound to form the sections 412,416. The collection mechanism 420 may include a vacuum or other suction device that may remove the unused build material 404 from the formed 3D object and to store the removed build material 404 in a reclaimed material hopper 422. As discussed herein, the build material 404 in the reclaimed material hopper 422 may be re-used and/or stored for future re-use, e.g., mixed with other build material for a future build cycle. In addition, although the collection mechanism 420 has been depicted as being located beneath the build platform 406, it should be understood that the collection mechanism 420 may be positioned above the build platform 406 and may also be movable with respect to the build platform 406.

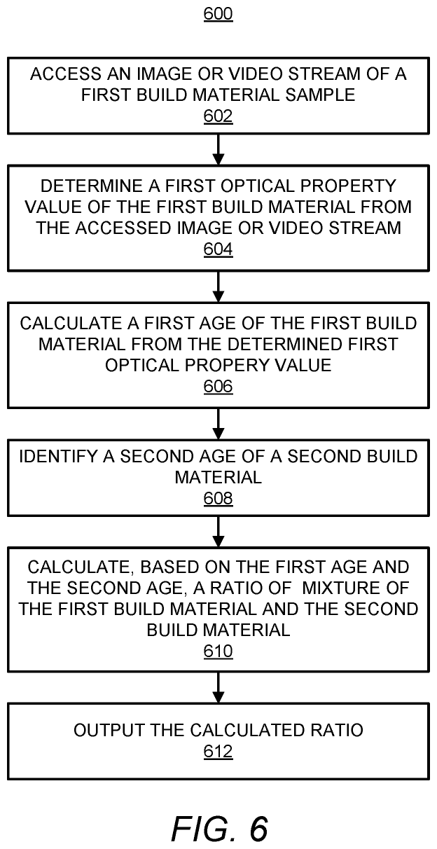

With reference now to FIG. 5, there is shown a block diagram of an example 3D fabrication system 500. It should be understood that the 3D fabrication system 500 depicted in FIG. 5 may include additional components and that some of the components described herein may be removed and/or modified without departing from a scope of the 3D fabrication system 500 disclosed herein. The description of FIG. 5 is made with reference to the elements shown in FIGS. 1-4 for purposes of illustration.

The 3D fabrication system 500 may include a build chamber 502 within which a 3D object 504 may be fabricated from build material 404 provided in respective layers in a build bucket 506. Particularly, a movable build platform 508 may be provided in the build bucket 506 and may be moved downward as the 3D object 504 is formed in successive layers of the build material 404. An upper hopper 512, which may also include a cyclone separator, may supply a spreader 510 with the build material 404 and the spreader 510 may move across the build bucket 506 to form the successive layers of build material 404. In addition, forming components 514 may be implemented to deliver an agent onto selected locations on the layers of build material 404 to form sections of the 3D object 504 in the successive layers. The forming components 514 may include an agent delivery device or multiple agent delivery devices, e.g., the supply device 418. Thus, although the forming components 514 have been depicted as a single element, it should be understood that the forming components 514 may represent multiple elements. A heating mechanism 414 to apply heat onto the layers of build material 404 to form the sections of the 3D object 504 may also be provided in the build chamber 502.

The 3D fabrication system 500 may include the apparatus 100, 300 discussed above with respect to FIGS. 1 and 3. The apparatus 100 may include a processor 102, 302 that may control various operations in the 3D fabrication system 500, including the spreader 510, the hopper 512, and the forming components 514. That is, for instance, the processor 102, 302 may control the forming components 514 to form the 3D object 504 in a volume of build material 404 contained in the build basket 506.

The build material 404 used to form the 3D object 504 may be composed of build material from a first supply 520 of build material, build material from a second supply 522 of build material, or a mixture thereof. The first supply 520 may represent a removable container that contains first build material that has undergone at least one 3D object formation cycle, e.g., build cycle. The first supply 520 may also or alternatively contain build material that has undergone different numbers of 3D object formation cycles with respect to each other. The second supply 522 may represent a removable container that contains second build material that has not undergone any 3D object formation cycles, e.g., build cycles, or have undergone a smaller number of build cycles than the first build material in the first supply 520.

As shown, the first build material in the first supply 520 may be provided into a first material bin 524 and the second build material in the second supply 522 may be provided into a second material bin 526. Additionally, the build materials in either or both of the first material bin 524 and the second material bin 526 may be supplied to the upper hopper 512 at various ratios as discussed herein. The build materials may be provided into the bins 524, 526 from the respective supplies 520, 522 prior to implementing a build cycle to ensure that there is sufficient build material 404 available to complete the build cycle.

Generally speaking, the processor 102, 302 may control the mixture or ratio of the first build material in the first material bin 524 and the second build material in the second material bin 526 that are supplied to the upper hopper 512. That is, the processor 102/302 may determine the ratio in any of the manners discussed herein and the processor 102/302 may control the ratio of the first build material and the second build material supplied to the upper hopper 512 through control of respective feeders 528, 530. A first feeder 528 may be positioned along a supply line from the first material bin 524 and a second feeder 530 may be positioned along a supply line from the second material bin 526. The first feeder 528 and the second feeder 530 may be rotary airlocks that may regulate the flow of the build material from the respective bins 524, 526 along a feed line 532 toward the upper hopper 512. The feed line 532 may also be supplied with air from an input device 534 to assist in the flow of build material from the bins 524, 526 to the upper hopper 512.

A third feeder 536, which may also be a rotary airlock, may be positioned along a supply line from the upper hopper 512 to the spreader 510. The upper hopper 512 may include a level sensor (not shown) that may detect the level of build material contained in the upper hopper 512. The processor 102, 302 may determine the level of the build material contained in the upper hopper 512 from the detected level and may control the feeders 528, 530 to supply additional build material in a particular ratio when the processor 102, 302 determines that the build material level in the upper hopper 512 is below a threshold level, e.g., to ensure that there is a sufficient amount of build material to form a layer of build material 404 having a certain thickness during a next spreader 510 pass.

The 3D fabrication system 500 may also include the collection mechanism 420 discussed above with respect to FIG. 4. The collection mechanism 420 may include a blow box 540, a filter 542, a sieve 544, and a reclaimed material hopper 546. Airflow through the collection mechanism 420 may be provided by a collection blower 548. The collection mechanism 420 may reclaim unused build material 404 from the build bucket 506 as well as from a location adjacent to the build bucket 506 as shown in FIG. 5. Particularly, as discussed above, following formation of the 3D object 504, the build material 404 may remain in unfused or unbound form and the collection mechanism 420 may reclaim the build material 404 that was not formed into the 3D object 504. That is, the unused build material 404 may be separated from the 3D object 504 through application of a vacuum force inside the build bucket 506. The collection mechanism 420 may also be vibrated to separate the unused build material 404 from the 3D object 504.

The unused build material 404 in the build bucket 506 may be sucked into the blow box 540 and through the filter 542 and the sieve 544 before being collected in the reclaimed material hopper 546. Additionally, during spreading of the build material 404 to form layers on the build bucket 506, e.g., as the spreader 510 moves across the build bucket 506, excess build material 404 may collect around a perimeter of the build bucket 506. As shown, a perimeter vacuum 516 may be provided to collect the excess build material 404, such that the collected build material 404 may be supplied to the collection mechanism 420. A valve 550, such as an electronically controllable three-way valve, may be provided along a feed line 552 from the build bucket 506 and the perimeter vacuum 516. In examples, the processor 102, 302 may manipulate the valve 550 such that unused build material flows from the perimeter vacuum 516 during formation of the 3D object 504 and flow from the build bucket 506 following formation of the 3D object 504.

A fourth feeder 554, which may also be a rotary airlock, may be provided to feed the reclaimed build material 556 contained in the reclaimed material hopper 546 to the upper hopper 512 and/or to a lower hopper 558. As shown in FIG. 5, the fourth feeder 554 may feed the reclaimed build material 556 through the feed line 532. A valve 560, such as an electronic three-way valve, may be provided along the feed line 532 and may direct the reclaimed build material 556 to the upper hopper 512 or may divert the reclaimed build material 556 to the lower hopper 558. The processor 102, 302 may also manipulate the valve 560 to control whether the reclaimed build material 556 are supplied to the upper hopper 512 or the lower hopper 558. As discussed above, the processor 102, 302 may make this determination based upon the ratio of fresh and recycled build material that is to be used to form the 3D object 504.

A fifth feeder 562, which may be a rotary airlock, may be provided to feed the reclaimed build material 556 contained in the lower hopper 558 to the first supply 522 and/or the first material bin 526. The processor 102, 302 may control the fifth feeder 562 to feed the reclaimed build material 556 into the first supply 522 in instances in which the reclaimed build material 556 is not to be used in a current build cycle. In addition, the processor 102, 302 may control the fifth feeder 562 to feed the reclaimed build material 556 into the first material hopper 526 in instances in which the reclaimed build material 556 is to be used in a current build cycle.

According to examples, some of the reclaimed build material 556 may be removed from the 3D fabrication system 500, e.g., from the reclaimed material hopper 546, from the lower hopper 558, the first supply 520, or the first material bin 524. The reclaimed build material 556 may be provided on a palette 220 (FIG. 2) and an image of the sample of the reclaimed build material 556 on the palette 220 may be captured and sent to the processor 102, 302. In addition, the processor 102, 302 may calculate the ratio of the first build material and the second build material using the image as discussed herein.

The 3D fabrication system 500 may also include a filter blower 570 that may create suction to enhance airflow through the lines in the 3D fabrication system 500. The airflow may flow through a filter box 572 and a filter 574 that may remove particulates from the airflow from the upper hopper 512 and the lower hopper 558 prior to the airflow being exhausted from the 3D fabrication system 500. In other words, the filter blower 570, filter box 572, and filter 574 may represent parts of the outlets of the cyclone build material traps of the upper and lower hoppers 512 and 558 and may collect particulates from the airflow in the upper and lower hoppers 512 and 558.

Although not shown in FIG. 5, the apparatus 100, 300 may also include an interface through which the processor 102, 302 may communicate instructions to a plurality of components contained in the 3D fabrication system 500. The interface may be any suitable hardware and/or software through which the processor 102, 302 may communicate the instructions. In any regard, the processor 102, 302 may communicate with the components of the 3D fabrication system 500 as discussed above.

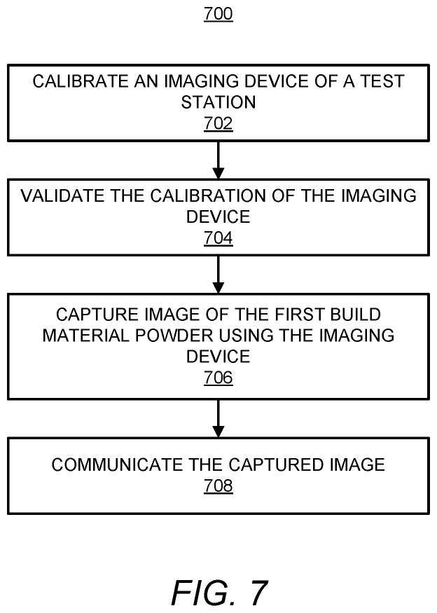

Various manners in which the apparatuses 100, 300 and the 3D fabrication system 500 may be implemented are discussed in greater detail with respect to the method 600 depicted in FIG. 6. Particularly, FIG. 6 depicts an example method 600 for calculating a ratio of a mixture of build materials such that the mixture may achieve a selected feature. It should be apparent to those of ordinary skill in the art that the method 600 may represent a generalized illustration and that other operations may be added or existing operations may be removed, modified, or rearranged without departing from a scope of the method 600.

The description of the method 600 is made with reference to the apparatuses 100, 300, the test station 210, and the 3D fabrication system 500 illustrated in FIGS. 1-5 for purposes of illustration. It should be understood that apparatuses, test stations, and 3D fabrication systems having other configurations may be implemented to perform the method 600 without departing from a scope of the method 600.

At block 602, the processor 102, 302 may access an image of a first build material sample. For instance, the processor 102, 302 may access an image or a video stream of the first build material sample 224 captured by an imaging device 212 of a test station 210 as shown in FIG. 2.

At block 604, the processor 102, 302 may determine a first optical property value of the first build material from the accessed image or video stream. As discussed herein, the processor 102, 302 may determine the first optical property value of the first build material through an analysis of the first build material contained in the image.

At block 606, the processor 102, 302 may calculate a first age of the first build material from the first optical property of the first build material. The processor 102, 302 may calculate the first age of the first build material in any of the manners discussed herein.

At block 608, the processor 102, 302 may identify a second age of a second build material. The second age may differ from the first age. The processor 102, 302 may identify the age of the second build material through a similar type of analysis on an image containing the second build material as discussed herein. In other examples, the processor 102, 302 may identify the second age from, for instance, a user input, accessing a source that has stored thereon a second optical property value, etc.

At block 610, the processor 102, 302 may calculate, based on the first age and the second age, a ratio of a mixture of the first build material and the second build material to be mixed together to cause a 3D object to be fabricated using the mixture to have a selected feature. The processor 102, 302 may calculate the ratio using information contained in a lookup table and/or through implementation of a predictive model as discussed herein.

According to examples, the processor 102, 302 may calculate the ratio to include a maximum concentration of the first build material in the mixture while achieving the selected feature of the 3D object to be fabricated using the first build material and the second build material mixed together at the calculated ratio. In instances in which the second build material is fresh, the amount of fresh build material used in a build cycle may be minimized, which may reduce costs associated with fabricating the 3D object using the mixture.

At block 612, the processor 102, 302 output the calculated ratio. That is, for instance, the processor 102, 302 may cause the calculated ratio to be displayed and/or may control the supply of the first build material and the second build material from bins 524, 526 at the calculated ratio as discussed herein.

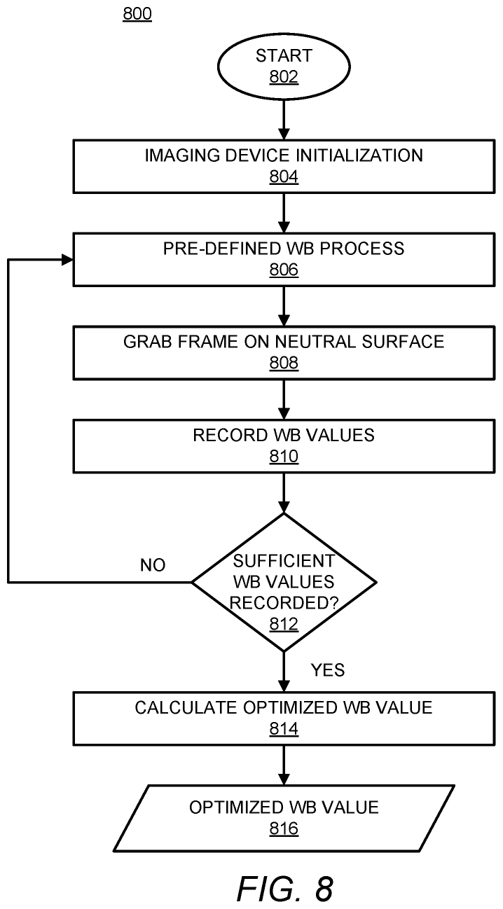

Turning now to FIG. 7, there is shown an example method 700 for capturing an image of the first build material sample. It should be apparent to those of ordinary skill in the art that the method 700 may represent a generalized illustration and that other operations may be added or existing operations may be removed, modified, or rearranged without departing from a scope of the method 700.

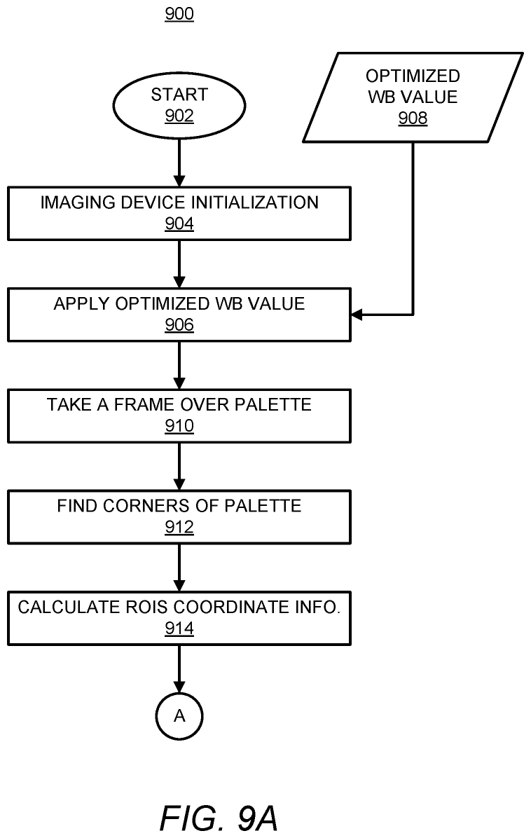

At block 702, an imaging device 212 of a test station 210 may be calibrated. That is, settings of the imaging device 212 may be calibrated to ensure that an output image (and/or video images) of the imaging device 212 responds similarly to a spectrophotometer. The calibration may also be implemented to ensure that the region of interest (ROI) on a captured image is cropped correctly. For instance, if the ROI on the captured image were cropped outside of the well of the palette 220, the image property validation may fail. At block 704, the calibration of the imaging device 212 may be validated. At block 706, the image of the first build material may be captured using the imaging device 212. In addition, at block 708, the captured image may be communicated to the processor 102, 302. Various manners in which the imaging device 212 may be calibrated and validated are described in further detail with respect to FIGS. 8, 9A and 9B.

Reference is now made to FIGS. 8, 9A, and 9B. FIG. 8 depicts a flow diagram of an example method 800 for calculating an optimized white balance (WB) value for an imaging device 212. FIGS. 9A and 9B, collectively, depict a flow diagram of an example method 900 for determining an age of a build material. It should be apparent to those of ordinary skill in the art that the methods 800 and/or 900 may represent generalized illustrations and that other operations may be added or existing operations may be removed, modified, or rearranged without departing from the scopes of the methods 800 and/or 900. It should also be understood that a processor, such as the processor 102, 302 may execute some or all of the operations set forth in the methods 800 and/or 900.

With reference first to FIG. 8, at block 802, the method 800 may start. The method 800 may start through a manual activation of an imaging device 212, through an automated activation of the imaging device 212, through an input of an instruction to start the method 800 in a computing apparatus, and/or the like. At block 804, the image device 212 may be initialized. At block 806, a pre-defined white balance process may be implemented in which, for instance, the imaging device 212 may be positioned, e.g., rotated, to be positioned to capture an image of a predefined location with respect to the imaging device 212. For instance, as shown in FIG. 2, the imaging device 212 may be rotated to capture an image of light emitted from a light source 214.

At block 808, the imaging device 212 may grab, e.g., capture, a frame on a neutral surface. For instance, the imaging device 212 may capture an image of the light emitted from the light source 204. At block 810, white balance values in the captured image may be recorded. At block 812, a determination may be made as to whether sufficient white balance values have been recorded. Based on a determination that sufficient white balance values have not been recorded, the pre-defined white balance process may be re-initiated at block 806. However, based on a determination that sufficient white balance values have been recorded, at block 814, an optimized white balance value may be calculated. According to examples, the optimized white balance value may be calculated through use of any of a number of statistics algorithms, such as averaging of the white balance values, taking the mode of the white valance values, doing linear regression to the white balance values, etc. Each of the statistics algorithms may use a different number of data sets, which may depend on the stability of the imaging device, light sources, environment, etc. The determination of which statistics algorithm to implement and the number of sufficient white balance values may be determined through experiments. In addition, at block 816, the optimized white balance value may be stored and/or outputted.

Turning now to FIGS. 9A and 9B, at block 902, the method 900 may start. In addition, at block 904, an imaging device may be initialized. At block 906, an optimized white balance value may be applied to images captured by the imaging device. The optimized white balance value 908 may have been determined through execution of the method 800 and may be used at block 906.

At block 910, a frame over a palette 220 may be taken. That is, the imaging device 212 may capture an image of a palette 220 containing a first build material sample 224. At block 912, corners of the palette 220 may be found. At block 914, regions of interest (ROIs) coordinate information may be calculated to be within the found corners of the palette 220. The ROIs may include regions on the palette 220 at which build material samples may have been provided. At block 916, the ROIs of a golden target may be cropped. A golden target may be an area with known, neutral, well-controlled, and accurate color, such as, for instance, the second sample 232. For example, the golden target may be a piece of white paper, a white background surface under the field of view of the imaging device 212, etc.

At block 918, a determination may be made as to whether the color of the golden target has been validated. Based on a determination that the color of the golden target has not been validated, e.g., has failed, at block 920, an error message may be outputted, e.g., displayed for a user. However, based on a determination that the color of the golden target has been validated, e.g., has passed, at block 922, the ROIs of the build material(s) may be cropped out of the captured image of the palette 220. In addition, at block 924, the image color information may be compared with the golden value 926. The golden target may have known color surface value that may be stored in a non-volatile memory or lookup table. Following white balance calibration of the imaging device 212 is completed, an image or video stream of the golden target (e.g., second sample 232) may be captured and the color value of the golden target may be determined. The determined golden target color value may be compared with the stored golden value to identify a variance. In addition, a determination may be made as to whether the white balance calibration process yielded a good or bad white balance value from the identified variance. At block 928, the age of the build material in the captured image of the palette 220 may be determined in any of the manners discussed herein. In addition, at block 930, a message regarding the age of the build material may be outputted, e.g., displayed.

Generally speaking, through implementation of the method 800, the exposure and the white balance of the imaging device 212 may be set using a known light source as a reference. That is the imaging device 212 may be calibrated using a known light source. In addition, the method 900 may be implemented to ensure that the calibration of the imaging device has been performed correctly. That is, a validation process may be performed following the calibration based on a predefined pass/fail criteria and the calibration may be confirmed or rejected based on the validation process. In the case of rejection, the imaging device 212 may enter a recalibration and subsequent revalidation. In addition, user feedback may be provided regarding when the imaging device 212 is to be directed to capture an image of the light source 214 and when the imaging device 212 is to view the optical target. Moreover, once the calibration of the imaging device 212 is validated, the build material samples in the palette 220 may be tested.

Some or all of the operations set forth in the methods 600-900 may be contained as utilities, programs, or subprograms, in any desired computer accessible medium. In addition, some or all of the operations set forth in the methods 600-900 may be embodied by computer programs, which may exist in a variety of forms both active and inactive. For example, they may exist as machine readable instructions, including source code, object code, executable code or other formats. Any of the above may be embodied on a non-transitory computer readable storage medium. Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

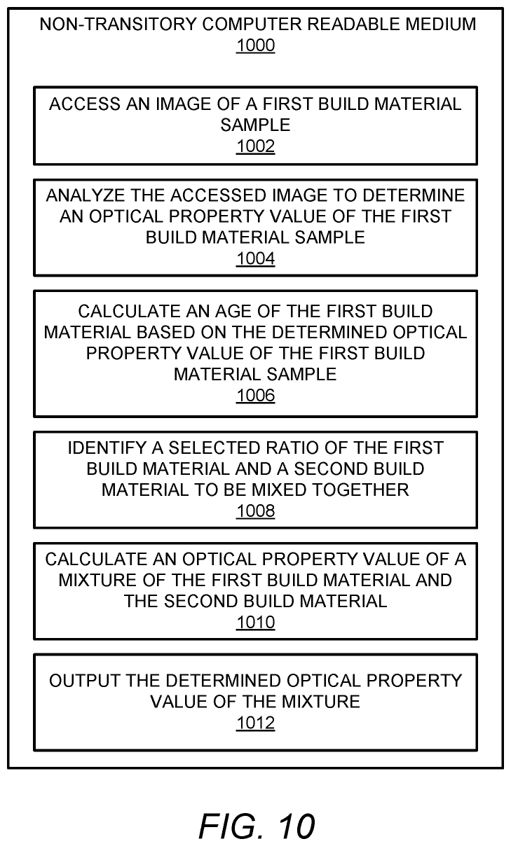

Turning now to FIG. 10, there is shown a block diagram of an example non-transitory computer readable medium 1000 that may have stored thereon machine readable instructions that when executed by a processor, may cause the processor to calculate an optical property value of a mixture of a first build material and a second build material prior to the first build material and the second build material being mixed together. It should be understood that the non-transitory computer readable medium 1000 depicted in FIG. 10 may include additional instructions and that some of the instructions described herein may be removed and/or modified without departing from the scope of the non-transitory computer readable medium 1000 disclosed herein.

The non-transitory computer readable medium 1000 may have stored thereon machine readable instructions 1002-1012 that a processor, such as a processor 102, 302, may execute. The non-transitory computer readable medium 1000 may be an electronic, magnetic, optical, or other physical storage device that contains or stores executable instructions. The -transitory computer readable medium 1000 may be, for example, Random Access memory (RAM), an Electrically Erasable Programmable Read-Only Memory (EEPROM), a storage device, an optical disc, and the like. The term “non-transitory” does not encompass transitory propagating signals.

The processor may fetch, decode, and execute the instructions 1002 to access an image of a first build material sample. The processor may fetch, decode, and execute the instructions 1004 to analyze the accessed image to determine an optical property value of the first build material. The processor may fetch, decode, and execute the instructions 1006 to calculate an age of the first build material based on the determined optical property value of the first build material sample. The processor may fetch, decode, and execute the instructions 1008 to identify a selected ratio of the first build material and a second build material to be mixed together, the second build material having an age that differs from the age of the first build material. The selected ratio may be a user-inputted selected ratio, e.g., a user may input a first concentration of the first build material and a second concentration of the second build material as the selected ratio. That is, a user may input an intended concentration level of the first build material and an intended concentration level of the second material to be used in a build cycle to the processor.

The processor may fetch, decode, and execute the instructions 1010 to calculate an optical property value of the mixture prior to the first build material and the second build material prior to being mixed together at the selected ratio. For instance, the processor may determine the optical property value based on previously stored correlations between various mixtures and ages. In addition or in other examples, the processor may determine the optical property value through implementation of a predictive model that may mathematically correlate an optical property value predicted to result from various mixture combinations.

The processor may fetch, decode, and execute the instructions 1012 to output the determined optical property value of the build material mixture. For instance, the processor may cause the determined optical property value of the build material mixture to be displayed on a display. A user may use the outputted optical property value to determine whether the selected ratio may result in a desired property of the build material mixture and/or a 3D object to be fabricated using the build material mixture.

According to examples, the processor may access images of a plurality of build material samples captured at a test station 220. The build material samples may be from multiple 3D fabrication systems. The processor may also analyze the accessed images to determine respective optical property values of the plurality of build materials. In addition, the processor may calculate a respective number of times each of the plurality of build materials has undergone build cycles from the determined respective optical property values, e.g., the processor may calculate the ages of the build materials. In one regard, the processor may calculate the respective optical property values of the plurality of build material s concurrently, which may reduce a total amount of time used to calculate the respective number of times each of the plurality of build material s has undergone build cycles.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure. For instance, although particular reference is made to a mixture of a first build material and a second build material, it should be understood features of the present disclosure may be directed to mixtures of more than two build materials.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a non-transitory computer readable medium on which is stored machine readable instructions that are to cause the processor to:
determine an optical property value of a first build material from an image of a sample of the first build material;
calculate an age of the first build material from the determined optical property value of the first build material; and
based on the calculated age of the first build material, calculate a ratio of a mixture of the first build material and a second build material that results in the mixture achieving a selected feature, the second build material having a different age than the first build material.

2. The apparatus of claim 1, wherein the instructions are further to cause the processor to:
implement a predictive model to calculate the age of the first build material based on the determined optical property value of the first build material, the age of the first build material corresponding to an apparent number of build cycles that the first build material has undergone; and
wherein, to calculate the ratio of the mixture, the instructions are further to cause the processor to calculate the ratio of the mixture of the first build material and the second build material based on the calculated age of the first build material.

3. The apparatus of claim 2, wherein the second build material has a different age than the first build material, and wherein the age of the second build material corresponds to an apparent number of build cycles that the second build material has undergone.

4. The apparatus of claim 1, wherein the instructions are further to cause the processor to:
output the calculated ratio of the mixture of the first build material and the second build material.

5. The apparatus of claim 1, wherein the first build material is stored in a first bin and wherein the second build material is stored in a second bin and wherein the instructions are further to cause the processor to:
control a supply of the first build material from the first bin and a supply of the second build material from the second bin according to the calculated ratio of the mixture.

6. The apparatus of claim 1, wherein the selected feature comprises an optical feature, a physical feature, a material feature, a chemical feature, or a combination thereof of a part to be fabricated using the mixture of the first build material and the second build material.

7. The apparatus of claim 1, wherein the instructions are further to cause the processor to:
determine optical property values of a plurality of build materials from images of samples of the plurality of build materials;
calculate ages of the plurality of build materials from the respective determined optical property values; and
wherein to calculate the ratio of the mixture, the instructions are further to cause the processor to calculate a ratio of a mixture of at least some of the plurality of build materials based on the calculated ages of the plurality of build materials.

8. A method comprising:
accessing, by a processor, an image of a first build material sample;
determining, by the processor, a first optical property value of the first build material from the accessed image;
calculating a first age of the first build material from the determined first optical property value;
identifying a second age of a second build material;
calculating, by the processor and based on the first age and the second age, a ratio of a mixture of the first build material and the second build material to be mixed together to cause a 3D object to be fabricated using the mixture to have a selected feature; and
outputting, by the processor, the calculated ratio.

9. The method of claim 8, further comprising:
calibrating an imaging device of a test station;
validating the calibration of the imaging device;
following the validation of the image, capturing the image of the first build material using the imaging device of the test station; and
communicating the captured image to the processor.

10. The method of claim 8, wherein calculating the ratio further comprises calculating the ratio to include a maximum concentration of the first build material in the mixture while achieving the selected feature of the part to be fabricated using the first build material and the second build material mixed together at the calculated ratio.

11. The method of claim 8, further comprising:
controlling a supply of the first build material from a first bin and a supply of the second build material from a second bin according to the calculated ratio to a fabrication area of a fabrication system.

12. The method of claim 8, further comprising:
applying a predictive model on the determined first optical property value of the first build material to calculate the first age of the first build material, the first age of the first build material corresponding to an apparent number of build cycles that the first build material has undergone.

13. The method of claim 8, wherein calculating the ratio further comprises calculating the ratio of the mixture based on previously stored correlations between various ratios of the first build material and the second build material and resulting properties of parts fabricated using the various ratios.

14. A non-transitory computer readable medium on which is stored machine readable instructions that when executed by a processor cause the processor to:
access an image of a first build material sample;
analyze the accessed image to determine an optical property value of the first build material;
calculate an age of the first build material based on the determined optical property value of the first build material;
identify a selected ratio of the first build material and a second build material to be mixed together, the second build material having an age that differs from the age of the first build material;
calculate an optical property value of a mixture of the first build material and the second build material mixed together at the selected ratio; and
output the determined optical property value of the mixture.

15. The non-transitory computer readable medium of claim 14, wherein the instructions are further to cause the processor to:
access images of a plurality of build material samples captured at a test station;
analyze the accessed images to determine respective optical property values of the plurality of build materials; and
calculate a respective number of times each of the plurality of build materials has undergone build cycles from the determined respective optical property values.
